(19) United States
(12) Patent Application Publication
(10) Pub. No.: US 2010/0223197 A1
(43) Pub. Date: Sep. 2, 2010

(54) Socially Aware Club Management

(76) Inventor: Stephen L. Ames II, West Valley City, UT (US)

Correspondence Address: Floris Chad Copier, 5373 W. 10480 N., Highland, UT, 84003, US

(21) Appl. No.: 12/715,182

(22) Filed: Mar. 1, 2010

Related U.S. Application Data
(60) Provisional application No. 61/156,248, filed on Feb. 27, 2009.

(51) Int. Cl. G06Q 10/00; G06Q 50/00; G06K 5/00

(52) U.S. Cl. 705/345; 705/346; 235/382

(57) ABSTRACT

A socially aware club management system is disclosed that provides compliance with the laws and patron relationship building by automating data collection while providing employees with relevant patron information to form lasting relationships. This information may be used in both real world and virtual world applications to keep the club in positive daily relationships with its patrons.

### PRIORITY

This application claims priority to U.S. Provisional Patent Application No. 61/156,248 filed Feb. 27, 2009, with the same title.

### FIELD

The present invention relates to customer relationship management. More specifically, the present invention relates to relationship management within a club.

### BACKGROUND

Customer Relationship Management (“CRM”) Software logs how a customer has interacted with a company. This can be through such touchpoints as a call-center, salesperson, technical support, tradeshow or a number of other relationships. This log provides a history for review to the next person to be contacted, giving context to this customer communication.

CRM Software depends on the quality of the data entered within it. This data quality can be affected by the person entering the data. Someone who does not have a significant stake in the outcome, such as a typical call center employee, may be careless with the log entry. Important details may be missed, confusing, incorrect, speculation or—worst of all—the opposite of what the customer presented. Such corruption makes the data difficult to trust and potentially harmful to the relationship it was meant to protect.

Some businesses depend more upon the customer relationship than others. Entertainment industries depend heavily on the customer relationship, often reducing the importance of other factors such as cost. Building relationships provides a competitive advantage, while the inability to do so can often mean a disadvantage.

Clubs depend heavily on the relationships with their patrons, because their membership and recommendations provide the “buzz” that makes a club successful. The difficulty with clubs is that any CRM data may be suspect because CRM data seems tangential to most club jobs. The bouncer is focused on gatekeeping, the bartender on his drinks, the cashier on the cash drawer and the DJ on his music. Further, the pay and hours may not attract the most diligent and schooled typists. Therefore any CRM data is likely suspect at best and potentially damaging for incorrect entries.

Some clubs depend on key charismatic employees who build relationships and remember people, making them feel important. The problem with these employees is not their success, but the fact that patrons bond with the employee instead of the club. The club runs the risk of the patrons following the employee, should the employee ever part ways with the club.

Further, clubs are frequently the targets of strict regulations and surprise visits checking up on these regulations. Frequently, efforts to police such things as age come off as intrusive, when a customer has to show her ID two or three times just to get in the door. However, the club owner that does not put in adequate compliance checks risks substantial fines and negative press.

### SUMMARY OF THE INVENTION

An improved club management system is taught below along with the Figures. According to one embodiment, a computerized scanning system is utilized to ensure regulatory compliance, while also giving the patron personal service. In some embodiments, data entry is automated or administered by a person who has a vested interest in and knowledge of correct data, resulting in higher expected data quality. The club may provide automated relationship building between the patron and the club both during a club visit and outside the boundaries of the club. The club may integrate the “real” club experience with the patron's “virtual” identity.

### BRIEF DESCRIPTION OF THE DRAWINGS

Various embodiments of the present invention are shown and described in reference to the numbered drawings as follows:

FIG. 1 shows a diagram of the software components available within the syste;

FIG. 2 shows a diagram of the interaction of an embodiment of the system in the Security and Compliance context;

FIG. 3 shows a flow chart of the process for an embodiment of the security and compliance management module;

FIG. 4 shows a diagram of an embodiment of the club experience management module;

FIG. 5 shows a diagram of an embodiment of the marketing management module;

FIG. 6 shows a diagram of an embodiment of an event management module;

FIG. 7 shows a diagram of an embodiment of the retail management module;

FIG. 8 shows a diagram of an embodiment of the website manager;

FIG. 9 shows a diagram of an embodiment of the employee manager; and

FIG. 10 shows a diagram of an embodiment of the administrative functionality.

It will be appreciated that the drawings are illustrative and not limiting of the scope of the invention which is defined by the appended claims. Together with the following description, the Figures demonstrate and explain the principles of inventive club management systems and methods for using and making the systems. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that embodiments of socially aware club management and associated methods can be implemented and used without employing these specific details. Indeed, exemplary embodiments and associated methods can be placed into practice by modifying the illustrated units and associated methods and can be used in conjunction with any other devices and techniques conventionally used in the industry. The drawings and descriptions are exemplary of various aspects of the disclosed embodiments and are not intended to narrow the scope of the appended claims.

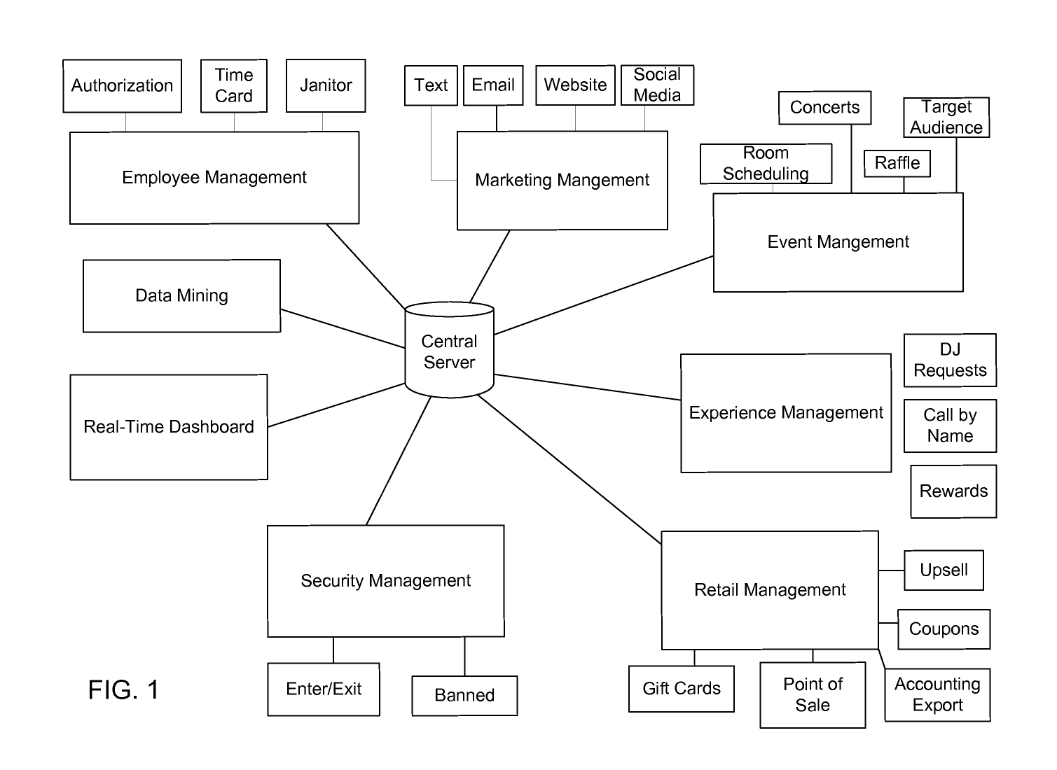

Turning now to FIG. 1, a diagram of the software components available within the system shows the relationship between the data store and the tools available to a user of the software. The system automates such functions as Security and Compliance Management, Retail Management, Experience Management, Event Management, Marketing Management, Employee Management, Corresponding Administrative functions, Data Mining and Reports. Each of the functions is represented in the diagram as a module.

Each module interacts with data from a central source. This central source insures that the data is not duplicated or inconsistent across modules. Further, a comprehensive history of customer interaction with the club is created that provides context and even customer preferences that occurred in other interactions with the club. An event that occurred in another club context will be known to the next employee. By utilizing these preferences, the club may build strong relationships and avoid poor relationships.

For example, a customer might sign up for entrance through the Security and Compliance Management (“SecCom”) self-serve interface. While the patron may scan her driver's license through the interface to provide her legal name, when a retail employee calls her by name, she may indicate a preference for a nickname. When the retail employee enters that nickname into the system, the nickname is available to all employees and modules. Thus the patron's next interaction, with someone like the DJ, will use her preferred name. As the system begins to gather enough data, the club itself begins to build a relationship with the patron. The patron feels important because “everyone knows her there.”

In a similar check, the club may avoid painful mistakes in keeping away from negative relationships. Clubs generally keep a list of “banned people” who have committed serious misconduct in the past. A banned person may be denied access to event ticketing, even before the purchase of the event tickets. This prevents confrontations at the door to the event, where denial of entrance to the banned person after purchase may get violent.

Interaction with patrons may also go beyond the boundaries of the club. The system may create social media accounts such as Facebook™ applications and groups, Match.com™ associations, and MySpace™ friends. Each of these virtual interactions provides more context as to patron preferences and relationships. These relationships not only provide future leads, but also opportunities to further service the patron by examining the patron's profile.

Further, by having a virtual club interaction, the patron continues to have a positive experience and associate interaction with their friends with the club. This blending of the virtual with the real world allows the club to integrate its presence into the daily life of the client rather than just time at the club.

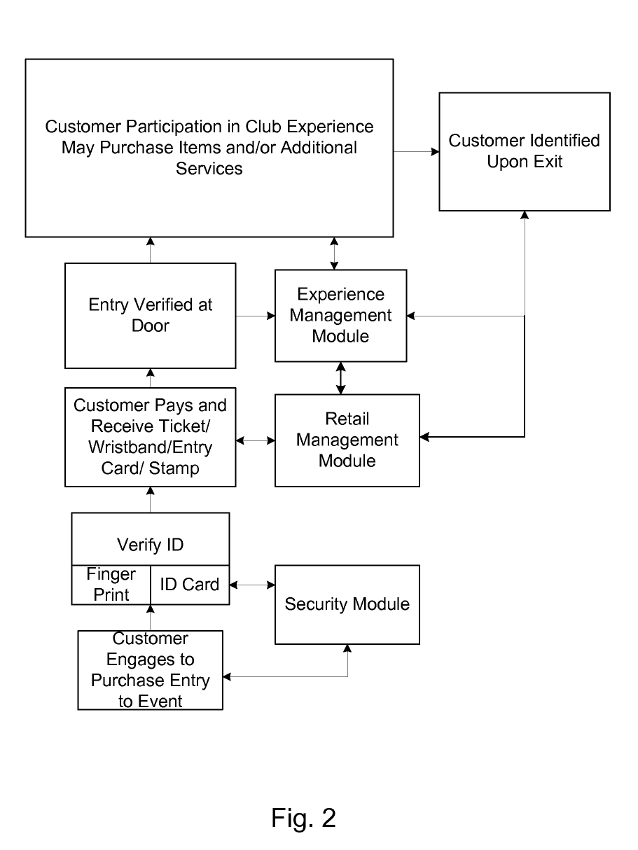

Turning now to FIG. 2, a diagram shows the interaction of an embodiment of the system in the Security and Compliance context. For compliance, it is important that a double or triple check of patrons be performed to prevent banned and underage patrons from entering the club. By combining the checks with personalization, what was once a hassle now becomes a potential to build a relationship.

Arriving at the bouncer/greeter, the patron's ID is read or biometrically scanned, such as a finger, into the computer. The patron's record is checked for being a member in good standing. Should the patron be new, the patron may be directed to self register at a kiosk. If the patron is banned, the patron is denied further access. Otherwise, the patron then waits for the front cashier to call the patron's name. The cashier double checks the patron's ID and processes the fees, unpaid tabs and may even register new members. Should the member or new member require an updated photo or information, the cashier may input the new data. The patron then approaches the stamper who verifies the payment and authorization to enter the club. If authorized, the stamper may allow the patron through a turnstile. The turnstile may also be selectively activated by communication through the SecCom module by a button press by the stamper, an ID scan, biometric scan or other identity verification technique. Therefore the patron in this embodiment may be checked up to three times for compliance and safety.

Once in the club, the patron may be checked for authorization when moving from room to room, exiting or purchasing an item. Compliance with club protocol and laws may be monitored by these authorization checks. For example, the system may track the number of people within rooms or the club such that occupancy levels are respected. During peak times, the club may monitor the exit and allow entrance to patrons only when other patrons have exited.

One advantage of this SecCom module is the ability to individually craft personal interaction with a patron. Once a patron's ID is read by a bouncer/greeter, who generally is not expected to know names, the cashier can invite the next person in line by name. By looking at the patron's history and/or script presented by the system, the cashier can present upsells, loyalty rewards, or even casual conversation about subjects noted within the system, such as music preference gleaned from event attendance. What was once an impersonal license check now became an interaction beginning with a call by name and ending with a conversation about subjects important to the patron.

Similarly, the stamper may now recognize the patron by name and suggest activities or inform the patron about friends that are present within the club, such as those who from part of the patron's Facebook™ friends. The stamper may even offer to text the patron's friends who have opted into the service about the patron's arrival.

By individually crafting personal interaction through knowledge gained by the system, both real and virtual, what was once an obvious security check becomes an opportunity to redirect the focus and show the patron that the club cares about them and their desires. In the background, the Security and Compliance requirements are met.

Security and Compliance are important in a club because of profit, liability and patron experience. People with past history of bad acts such as violence, sexual misconduct, and even an unpaid tabs cause negativity and problems for the other patrons. The risk of entrance of a “banned person” is reduced by automating the response rather than depending on facial or name recognition by an employee according to a list of banned people.

Another advantage of the embodiment is that the data quality is ensured. ID's are scanned or biometrics used to identify patrons, if possible, which substantially reduces errors including names that may seem similar enough for an employee to miss. Further, the guests or new members who register may input the data themselves through a registration terminal. As the patron is likely invested in their correct data and the best source of knowledge about themselves, the data quality of self-registration is generally high.

For manually entered data, such as new member by the greeter or cashier, the data may be double checked by the cashier and stamper. This double checking not only ensures data quality, but also ensures compliance as shown above.

Data input to the system may be automated by several different means. The patron may have an ID barcode scanned, magnetic stripe read, biometric scan or even an embedded RFID chip read. These encodings may be included in Drivers Licenses, club ID's, passports, credit cards or even a bracelet obtained upon entrance.

This data may be tied back to the patron such that tab may be formed, without the need for payment to be presented at the time of purchase. For example, a patron may scan her thumb at the bar counter to request to be put in the queue for service. As the bar tender finishes an order, the next client's picture, name and last orders may come up. The bar tender may then approach the patron, call her by name, and ask if she would like her “usual” and name the drink. Should the “usual” drink be unavailable, the bar tender may proactively redirect the patron to another drink that she had ordered in the past, avoiding a conflict. Further, the bar tender avoids the conflicts of lines or crowds, but instead knows the exact order of purchases. In fact, the bar tender approaches the client instead of the client seeking or fighting for the bar tender's immediate attention.

Data collected by the SecCom module may include biographical information, contact information, payment information, past interaction with the club, event attendance information, photographs, VIP classification, and other purchases.

While the SecCom system is shown as a series of discrete steps and personnel, it will be appreciated that functions and personnel responsibilities may be combined. For instance, the bouncer and cashier may be combined such that the cashier will not only take payment, but also act as the gatekeeper. Similarly, the stamper may track patrons as they both enter and exit the club.

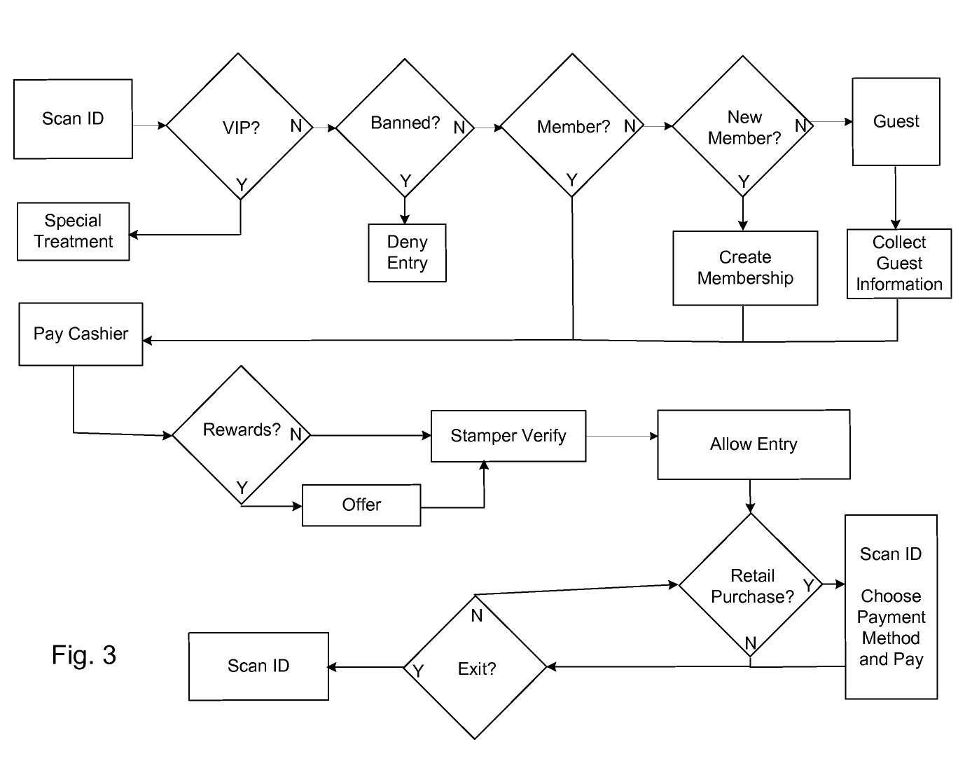

Turning to FIG. 3, a flow chart shows an embodiment of the process for the SecCom system. An ID is scanned which identifies the patron as a VIP, banned, member, new member or guest. If banned, the patron will be stopped from entering the club. If VIP, the patron will be directed to special treatment such as immediate entry. If a new member or guest, a sign up form will be required. Then the VIP, member, new member and guest may be called by the cashier for verification of their ID and to pay any charges required. The cashier may look at the past history of the patron and give any rewards, make small talk based on noticed interests or upsell the patron with relevant offers. The stamper then may verify that the patron has paid and is entitled to enter the club. Once inside, the patron may choose to spend more money, and may be identified personally by such things as biometrics, RFID, barcode, magnetic stripe or other automated means. The system may use stored information or new payment information to authorize any purchases by the patron. Finally, the exit time may be noted within by the system when the patron leaves.

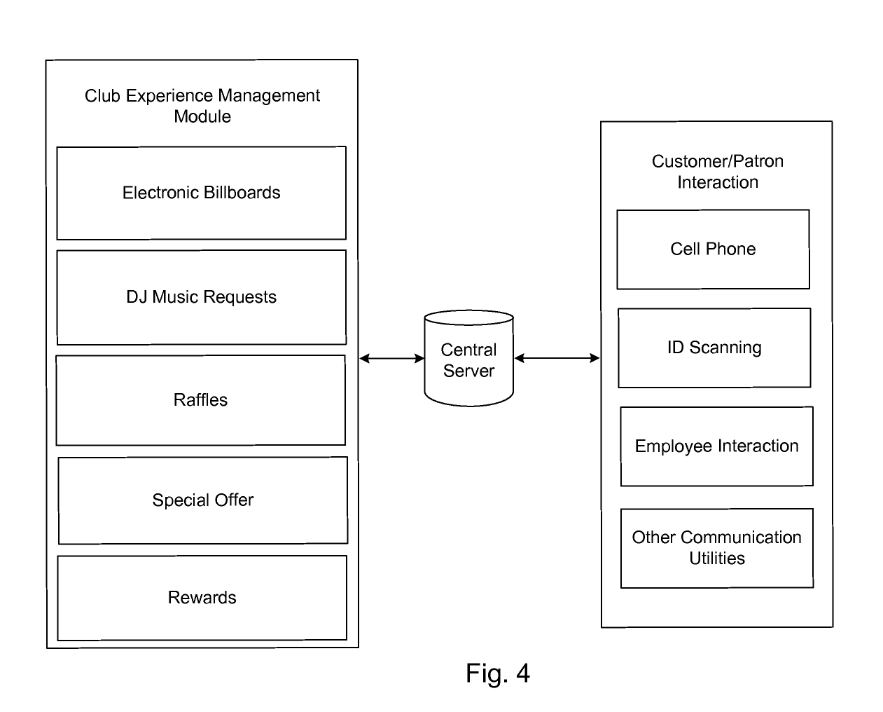

Turning now to FIG. 4, a diagram of an embodiment of the club experience management module is shown. A customer's interaction with the club through cell phone, ID scanning, employee interaction and other communication utilities (i.e. Facebook®, Twitter®, text message, email, etc.) is stored within a central database. Based on these interactions and preferences of the patron, opportunities to interact with club systems become available, such as electronic billboards, music requests, raffles, special offers and loyalty rewards programs.

For instance, the club has many options to interact with the patron. If the patron has given permission to interact with the club through text messaging, the patron may choose to request a song from the DJ via text messaging. Raffles may be entered by an automated scanning of an ID or text messaging a number. Staff may be notified of emergency calls and shown a picture of the patron needed. The electronic billboards may be interactive such that a patron can text the billboard to give a “shout out” to her friends. In fact, the system may even be configured to notify the patron that her friends have arrived through text messaging.

Administration of the club experience module may include such features as moderation of the billboards and DJ request queue, administration of the raffles and special offers. With an increased VIP level, more features may be configured to be available to a patron.

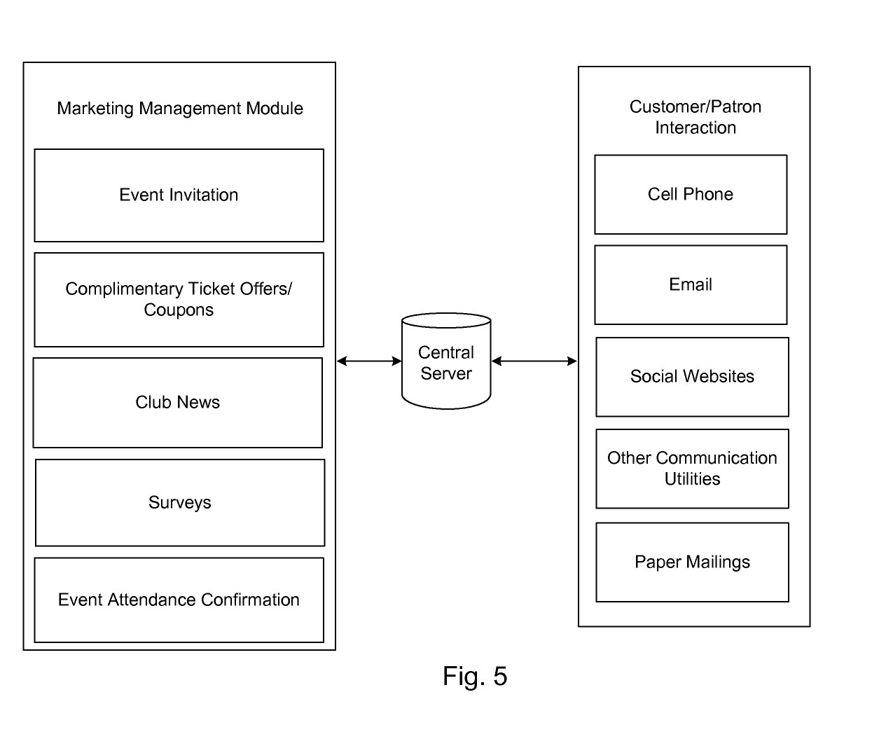

Turning now to FIG. 5, a diagram of an embodiment of the marketing management module is shown. A patron can opt-in to channels of contact that keep the patron connected with the club, when not attending the club. Messages and features may be tailored to the needs of the patron as may be deduced from the data available on the patron, providing meaningful contact. This contact can be integrated with the other modules, such that important information is relayed to the patron. Event ticket dates, expiring membership, closures and other notices relevant to the patron may be sent through the channels that the patron has self-selected.

Further, social media applications may be leveraged to aid in patron retention, patron acquisition and sales. For instance, a Facebook™ application may be used to learn about friends of the patron. The patron and her friends may set up messaging such that when a friend arrives at the club, the other friends are notified to come join her. Similar social connections with other websites such as MySpace™ or Match.com™ may be implemented to take advantage of a patron's social network and introduce the club into a patron's daily life.

Relationships with patrons may be further strengthened by sending birthday cards, relevant event invites, coupons, reminders, surveys and newsletters with relevant information. As each of these communications may be custom tailored to the desires of the patron, according to records within the database that include club attendance, purchases and preferences, the patron who opts-in to the communication appreciates the contact because it is relevant to her needs and arrives through the desired channels of contact. The channels of contact may include text, email, print to mail, social networking sites, embedded links and combinations thereof. These channels may also be completed through local services, such as staff printing and mailing birthday cards, or online services, such as posting to a Facebook™ wall or a direct-mailing service.

The marketing module may be configured for double opt-in techniques, such that accidental or malicious misuse of the system is substantially reduced. Further, a double opt-in system insures that the patron desires the interaction available through that channel of contact. Double opt-in also continues the assurance of data quality received through that channel, because the patron herself assures the club of that channel's importance by the double opt-in process.

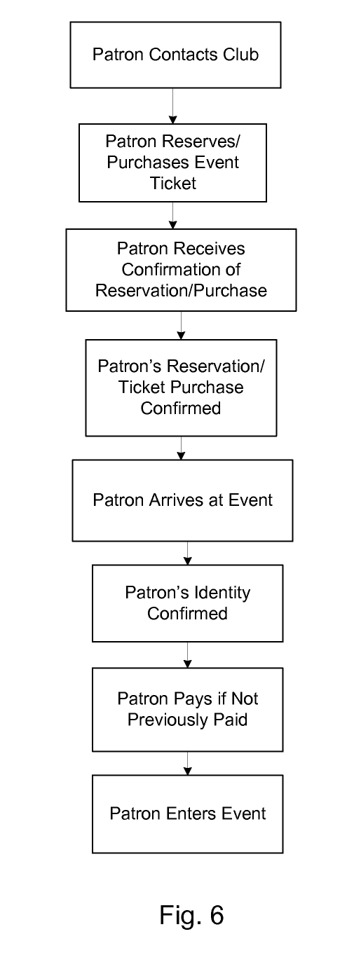

Turning to FIG. 6, a diagram of an embodiment of event management module is shown. A patron may reserve tickets to the event from a website, phone or in person request. Payment may be processed through the system and corresponding ticket inventory may be reduced. The tickets may be printed by the employee and handed to the patron, mailed, electronically delivered or sent to will-call for pickup. On the day of the event, the patron may enter through the Security and Compliance process described above. Because of the automated system, the system not only knows about the attendance numbers and names, but also can attach a preference to the attendee for the event.

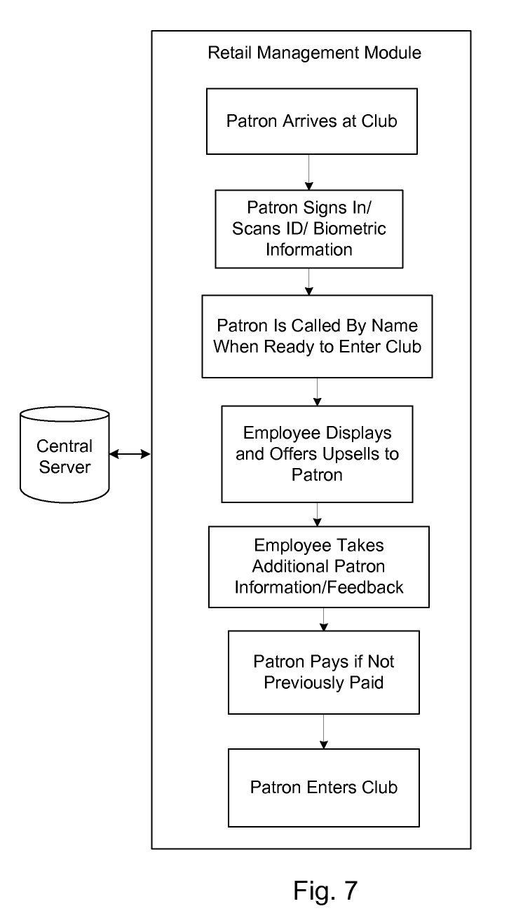

Turning now to FIG. 7, a diagram of an embodiment of the retail management module is shown. A patron may add herself to the queue for service. When the employee has completed a prior transaction, the next patron may be displayed to the employee who then addresses the patron by name. The system may display any upselling or special offers, as well as pertinent questions, such as asking about how the patron may have liked the previous purchase. The payment may be processed by cash, check, credit card or even adding it to the patron's “tab.” Often, this processing is done at a local payment terminal, but may be done through wirelessly through a mobile ID reader, biometric scan or credit card reader.

This system not only aids in building the patron relationship, but it may reduce fraud by both tying a patron identity, such as a picture, with payment information such that an employee may verify identity and hesitancy of any potential thief caused by knowing that the club does the tying of picture to payment discouraging anonymous fraud. As each patron is identified by name, fraud becomes more difficult.

In another embodiment, the retail management module is simplified. Upon taking desired items to the cashier, the member ID is noted and the individual items are entered into the system for purchase. The system generates a total and receipt. The system may take the payment directly, or a payment type may be noted in the system and a separate payment processor utilized.

In another embodiment, the retail management module connects with a point of sale (“POS”) program, which may be an off the shelf version such as those produced by Intuit™. Any transaction processed by the POS program may be transmitted, imported or otherwise available to the retail management module.

The retail management system may also include supply chain management, inventory management, and taxes setup. Purchase orders may be automatically generated upon a low stock status and sent for administrative review. Reports and warnings of stock status may be sent to an employee, when an item becomes popular or at a low stock level. Cost of Goods may also be tracked, including FIFO, LIFO and average cost. The system may also account for lead-times in the warnings, such that long-lead time items will be given a low-stock status before a short-lead item. Further, the system may warn of potentially unprofitable items. Profitable items may also be noted such that sufficient inventory is ordered.

The system may also track cash drawers. Overages and underages may be detected, appropriately dealt with and may be attached to the employee record. The system may also monitor the cash drawer in real-time and send messages to a manager when the cash drawer contains money beyond a specified limit. This limit may be configured to exclude certain payment types, such as gift-card receipts or tab receipts, that are not greatly effected by a stolen cash drawer. Similarly, the retail management module may also be able to monitor cash sales and warn a manager when the cashier may need an influx of low denomination bills or coins.

The rules for discounting and profitability may also be set in the administrative panel of the retail management module. Items such as alcohol may be restricted from discounts, while other items may be restricted to discounts above cost. Further, special rules may be set-up based on VIP levels.

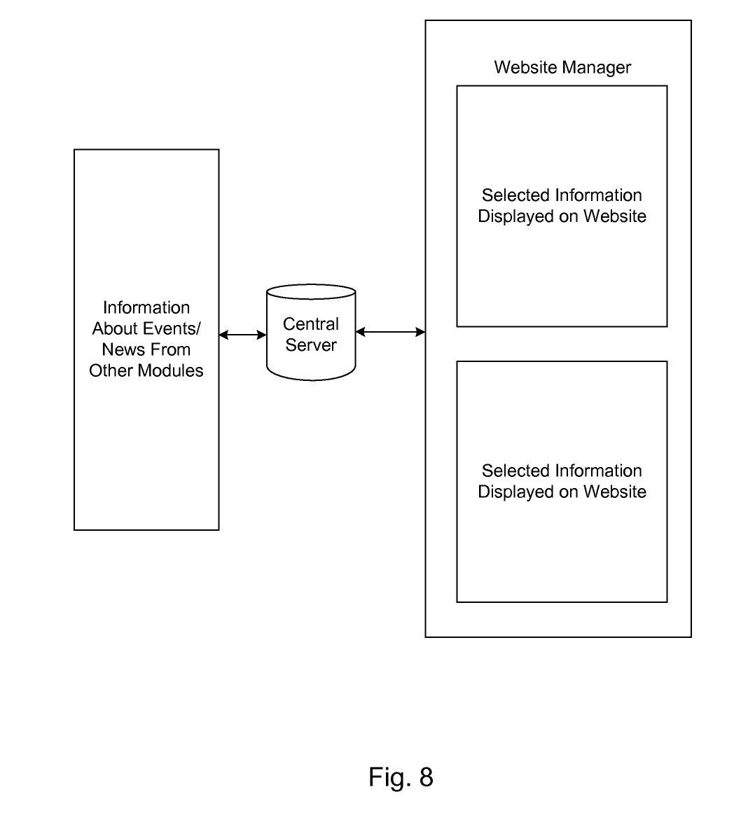

Turning now to FIG. 8, a diagram of an embodiment of the website manager is shown. The website manager may selectively place information from the database on the website, keeping data internal to the system in sync with the information given to the public. The information may have come from any of the other modules in the system or specific information not found in the modules, such as a lost and found section.

The website manager may further provide services such as calendaring, sponsorships, scheduling and even reservations that integrate with other modules. Marketing information, such as PR, social network groups and applications, and even blog or twitter™ content may be created for the website.

The website manager may also cooperate with other modules. The social media interface may be used to keep members updated of similar items as posted on the website. Further, the website manager may cooperate with the marketing manager to assure coherent messages and styles.

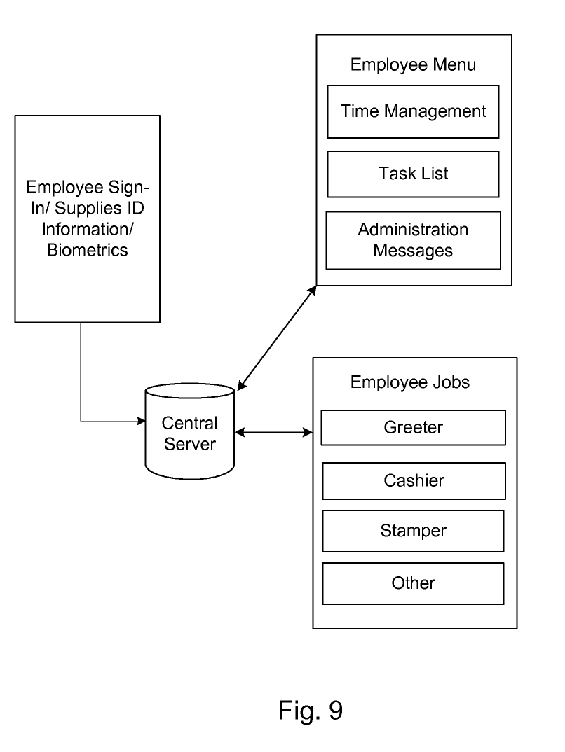

Turning now to FIG. 9, a diagram of an embodiment of the employee manager is shown. The employee manager may contain such functionality as timekeeping, assignments, scheduling, duties, policies and payroll.

As the data entry is automated—such as a swipe of a badge, biometic scan or a username/password or a combination of any two—redundant data entry is reduced and accuracy may be assured in timekeeping and payroll. Some assignments may be system monitored, such as cashiers, since every transaction is recorded. A runaway cashier would likely show no transactions over the period of time she disappeared. On the other hand, efficient employees might show more transactions than expected. Similar monitoring might detect understaffing by a constant stream of transactions without any reasonable breaks.

The system may dynamically self-correct. Should an employee no-show or become ill, the system may request a co-worker fill the more important position by examining the schedule and assignments. This request may go directly to the substitute employee or be sent in a notification to the administrator of the system. The no-showing employee may be sent an automated message requesting they immediately contact the manager at a specified number to explain the delay. Such messaging can occur by text, email, automated computer call or other channel specified by the manager or the employee herself.

The system may be configured to make a note of any employee issues, such as the no-show situation described above. The system may attach the note, along with any manager comment, to the employee's records and also display a list of such notes on the manager's dashboard screen. The system may also be configured to notify the manager by a pre-selected communication channel of any issues, such as the no-show of an employee, along with potential corrective information, such as the employee's contact information.

Further, the employee manager module may define security roles and enforce them. These roles may even be dynamically assigned based on the assignments for the day or the computer station where the employee logs in (i.e. a greeter station should not be logged in as a website adminstrator). The roles may also be based in the level of trust of the employee or employee position. As the employee is more trusted, more sensitive data may be exposed and edited.

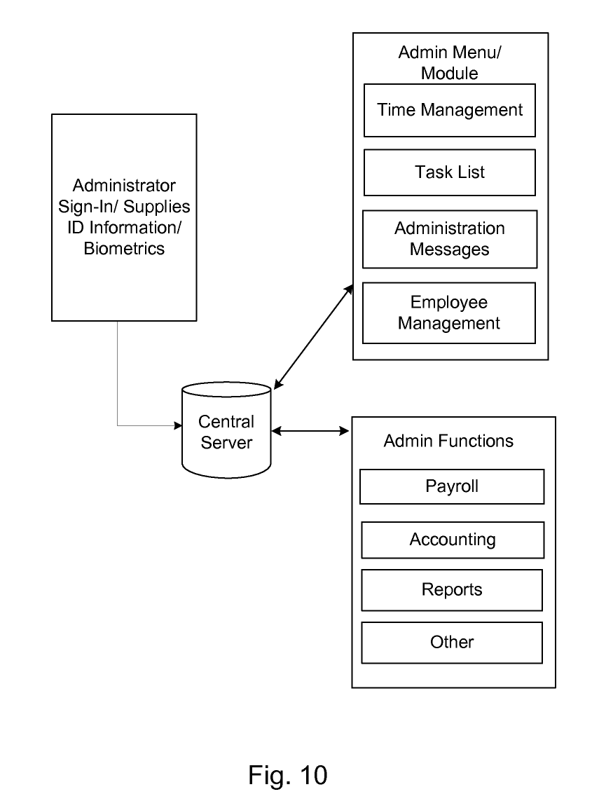

Turning now to FIG. 10, a diagram showing an overview of an embodiment of the administrative functionality is shown. The administrative portion touches all aspects of the system. The roles defined by the employee management module would likely determine the extent of access into the administrative system. The administrative system has the purpose of not only administering the data and program functionality, but also providing additional hardware functionality to grow with the club.

In the security management system, administrative functions may include banning patrons, modifying patron data, adding new patrons and guest management. Different member and guest types may be setup to match actual scenarios, such as a patron guest versus an event guest.

In the retail system module, administration may include setting up product and sales management, including new upsells, combinations and discounts.

In the experience management module, DJ music requests, electronic billboard requests, raffles and other interaction may be controlled from the system login. In fact, it may be advisable to have a moderator for any customer distributed content.

Similarly, in the marketing management module, marketing campaigns, such as email, texting, print to mail and coupons and customer social networking, may be created and monitored by the administrator. In the social networking websites, a moderator may be advisable so that offensive posts do not make it to the other patrons.

In the event management module, the administrator may have the ability to plan events and reserve rooms and equipment. This includes seating arrangements, capacity, calendar, requirements, ticket face design, promotion pricing, entertainment planning, timeliness of events, details of promotions, task list tracking, and tracking custom event information.

Finally, the administrative panel also includes report generation. The reporting module may run several types of reports. One report may be realtime data, showing current needs, problems and/or occupancy. Another set of reports may be scheduled to run later and mine customer data to glean a greater understanding of clients.

Reports may be exported or imported from other programs such as accounting programs, like Quickbooks®, Peachtree®, or other similar software, for specialized use or general programs, like excel, for further data exploration. These reports may be scheduled or created on-demand. In fact, the system may be configured to interact with other databases, such as the accounting program, as needed. Any important information gained may be similarly sent to the manager by a communications channel previously selected by the manager. The data may also be utilized by any of the modules if so configured. The data may also be held from the central database until approval by a manager to preserve data quality.

Realtime data and data summaries may be generated as a “dashboard” report for the administrative panel. Events of interest, including those discussed above in the different modules, may be directly displayed or summarized on the realtime display. Each module may have configurable realtime reports that be shown on the dashboard or in a separate administrative menu.

It should be appreciated that a specific embodiment may consist only of a subset of the modules or portions of modules without departing from the scope of the specification. Not every club will require every feature. It should be further appreciated that the database and modules may be distributed across several computers or presented on a single computer, depending on the client requirements. Furthermore, the system may be on a local network, wireless network or provided over a secure internet connection.

There is thus disclosed an improved socially aware club management system. It will be appreciated that numerous changes may be made to the present invention without departing from the scope of the claims.

What is claimed is:

1. A club management system comprising:
a queue;
a service that is desired by a plurality of patrons;
a computer, that is configured to place a request for at least one of the plurality of patrons to be placed in the queue;
an identity reader configured to read a personal identifier of the at least one of the plurality of patrons and communicate the identifier to the computer; and
a display accessible by a service provider that is configured to identify to the service provider a next patron within the queue to give the service.

2. A club management method comprising:
reading a patron's ID by a machine;
retrieving access privileges of the patron from a database;
transmitting the identity information from the machine to a second station;
calling the patron to the second station by name;
verifying the identity of the patron; and
providing access into a club based on the access privileges and success of the verifying step.

3. A club management system comprising:
a database;
a new patron module configured to insert new patrons into the database;
a security and compliance module configured to machine read a patron's personal identifier and transmit a request to an employee to verify identity before allowing the patron entrance to the club, and recording such activity within the database;
a retail module configured to track and process sales within the club; and
a marketing module configured to transmit communications to the patron based at least partially on the context of the patron visit recorded by the security and compliance module within the database.
